(19) United States
(12) Patent Application Publication
(10) Pub. No.: US 2009/0032284 A1
(43) Pub. Date: Feb. 5, 2009

(54) "Spider" bracket

(76) Inventor: Weixiong Huo, Las Vegas, NV (US)

Correspondence Address: Weixiong Huo, 7497 Coral River Dr., Las Vegas, NV, 89131, US

(21) Appl. No.: 11/888,636

(22) Filed: Aug. 2, 2007

(51) Int. Cl. H02G 15/24

(52) U.S. Cl. 174/21 R

(57) ABSTRACT

This design of the invention is for support electrical conduit and flexible tube,cable by One-hole strap or mini-strap at the Cable-tray, Junction-box,electrical panel or other electrical enclosures.

### CROSS-REFERENCE TO RELATED APPLICATION

Slider blacket.

### FEDERALLY SPONSORED RESEARCH

Not applicable.

### SEQUENCE LISTING OR PROGRAM

Not applicable.

### BACKGROUND OF THE INVENTION

Field of Invention

The purpose of this invention is to support electrical Conduit and flexible cable being straped by Mini-straps And One-hole straps.

2. Background of the Invention

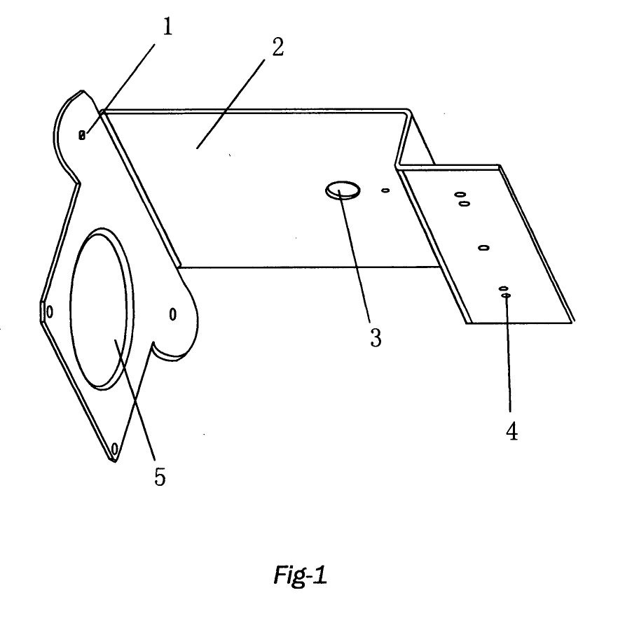

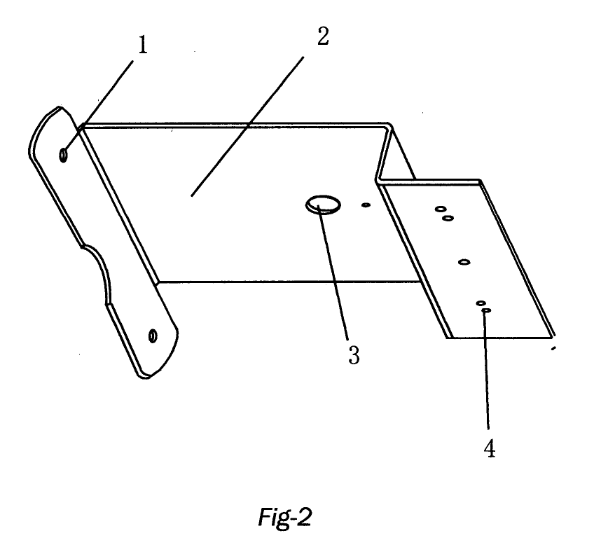

This bracket is fastened to the cable tray, junction bax Or other electrical enclosures by screws. It has a hole to match the size of conduit of connector on cable tray,junction box,and electrical enclosures, also the FIG. 2 bracket can fix direct on those electrical appliance.

This invention of bracket is much more convenience and to application of ceiling space and weather proof wall with electical enclosures.

I Claim;

1. The design of the function

2. Design of configuration.

3. product of invention.
